(19) United States
(12) Patent Application Publication
(10) Pub. No.: US 2007/0217391 A1
(43) Pub. Date: Sep. 20, 2007

(54) Methods, systems, and computer program products for setting congestion levels for a plurality of routes to a common destination

(75) Inventors: John L. Hildebrand, Hillsborough, NC (US); Komal G. Khungar, Morrisville, NC (US)

Correspondence Address: JENKINS, WILSON, TAYLOR & HUNT, P. A., SUITE 1200, UNIVERSITY TOWER, 3100 TOWER BOULEVARD, DURHAM, NC, 27707, US

(73) Assignee: Tekelec

(21) Appl. No.: 11/413,611

(22) Filed: Apr. 28, 2006

Related U.S. Application Data
(60) Provisional application No. 60/783,095, filed on Mar. 16, 2006.

(51) Int. Cl. H04L 12/28

(52) U.S. Cl. 370/351

(57) ABSTRACT

Methods, systems, and computer program products for setting congestion levels for a plurality of routes to a common destination are disclosed. According to one method, a transfer controlled (TFC) message concerning a destination is received at a signaling message routing node that maintains a plurality of routes to a common destination. The signaling message routing node tests a congestion level of each of the routes to the destination. The signaling message routing node sets congestion levels for the routes based on results of the testing.

### RELATED APPLICATIONS

This application claims the benefit of U.S. Provisional Patent Application Ser. No. 60/783,095, filed Mar. 16, 2006; the disclosure of which is incorporated herein by reference in its entirety.

### TECHNICAL FIELD

The subject matter described herein includes methods, systems, and computer program products for setting congestion levels for routes to a destination. More particularly, the subject matter described herein includes methods, systems, and computer program products for setting congestion levels for a plurality of routes to a common destination.

### BACKGROUND ART

In telecommunications networks, it is sometimes desirable to maintain multiple routes to a destination. For example, in SS7 networks, it may be desirable to maintain a primary route and one or more exception routes to a destination. The primary route may be a default route that provides a standard quality of service, and the exception routes may be routes that provide enhanced quality of service for signaling messages. In one exemplary implementation, the primary route may be keyed by a signaling message parameter, such as a destination point code, and each of the exception routes may be keyed by the destination point code and one or more parameters in addition to the destination point code.

One problem associated with maintaining multiple routes to the same destination is congestion management. When congestion occurs on a signaling link in an SS7 network, the signal transfer point (STP) that detects the congestion marks the destination as congested. When the STP receives a message signaling unit (MSU) intended for the congested route, the STP will send a transfer controlled (TFC) message to the message originator. The TFC message includes a congestion level. The congestion level indicates a priority level of messages that will be allowed to be sent over the congested route. For example, if the congestion level is three, only messages with a priority level of four or higher will be allowed over the congested route. Lower priority messages will be discarded.

When a signaling node receives a TFC message indicating that a destination is congested, the signaling node may periodically verify that the indicated destination is still under congestion. This is necessary because there are no indications sent by the originator of the TFC message that the destination is no longer under congestion, if the congestion level remains constant. In order to determine whether a route is still under congestion, a signaling node may send a route set congestion test (RCT) message with a priority level set to one less than the congestion level in the TFC message to the destination. The signaling node also sets a timer. If no response is received within the timeout period, it is assumed that the RCT message was allowed to pass to the destination. In response to expiration of the timeout period without receiving a TFC message, the signaling node sets the congestion level of the route to one less than the previous congestion level and formulates a new RCT message. The signaling node then starts a timer and sends the RCT message to the destination over the congested route. If a TFC message is received within the timeout period, the signaling node maintains the current congestion level and sends another RCT message after another timer expires. The congestion level in the RCT message is set to the same value as the previous RCT message. If a TFC message is not received within the timeout period, the congestion level is decremented and an RCT message is sent with a priority of one less than the current congestion level. This process is repeated until the congestion level of the destination is determined to be zero.

One problem with implementing such congestion management procedures in a network where a signaling message routing node maintains multiple routes to the same destination is that the signaling message routing node cannot determine which route is experiencing the congestion. For example, the TFC message includes a concerned point code parameter that identifies the congested point code, which identifies the destination. However, there are no additional parameters in the TFC message that can be used to determine whether the TFC message concerns the primary route or one of the exception routes to the destination. If a TFC message concerns one of the exception routes, it may not be desirable to set the other exception routes or the primary route as congested. Similarly, it may be also be desirable to avoid oscillation between congested and non-congested states on a route.

Accordingly, in light of these difficulties associated with conventional congestion management and routing procedures, there exists a need for methods, systems, and computer program products for setting congestion levels for a plurality of routes to a common destination.

### SUMMARY

According to one aspect, the subject matter described herein includes a method for setting congestion levels for a plurality of routes to a common destination. The method includes receiving a transfer controlled (TFC) message at a signaling message routing node that maintains a plurality of routes to a common destination. The signaling message routing node tests each route to the destination and sets the congestion levels of the routes based on the testing.

In one implementation, the signaling message routing node may broadcast an RCT message over the primary route and all of the exception routes to a destination. Congestion levels for all of the routes may be set to the level corresponding to a TFC message received on any of the routes. This method prevents oscillation between congested and non-congested states. This method also ensures that all routes are treated equally when congestion status is received regarding one of the routes. However, it allows an exception route to control the congestion status of a primary route, which may not be desirable in some architectures.

In an alternate implementation, the signaling message routing node may individually test each route for its congestion status. The testing may be performed by sending an RCT message to the destination over each route and setting the status of each route based on a response to the RCT message or the absence of a response. Individually testing and setting the congestion levels allows a primary route to maintain an uncongested status when one of the exception routes has a congested status.

The subject matter described herein for setting congestion levels for a plurality of routes to a common destination may be implemented using a computer program product comprising computer executable instructions embodied in a computer readable medium. Exemplary computer readable media suitable for implementing the subject matter described herein include chip memory devices, disk memory devices, application specific integrated circuits, and downloadable electrical signals. In addition, the subject matter described herein may be implemented on a single device or a computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a flow chart illustrating exemplary overall steps for setting congestion levels for a plurality of routes to a common destination according to an embodiment of the subject matter described herein;

FIG. 2 is a network diagram illustrating a broadcast method for setting congestion levels for a plurality of routes to a common destination according to an embodiment of the subject matter described herein;

FIG. 3 is a flow chart illustrating exemplary processing steps corresponding to the example in FIG. 2;

FIG. 4 is network diagram illustrating an exemplary individual search method for setting congestion levels for a plurality of routes to a common destination according to an embodiment of the subject matter described herein;

FIGS. 5A and 5B are is a flow chart illustrating exemplary processing steps corresponding to the example illustrated in FIG. 4; and

FIG. 6 is a block diagram illustrating a signaling message routing node that sets congestion levels for a plurality of routes to a common destination according to an embodiment of the subject matter described herein.

### DETAILED DESCRIPTION

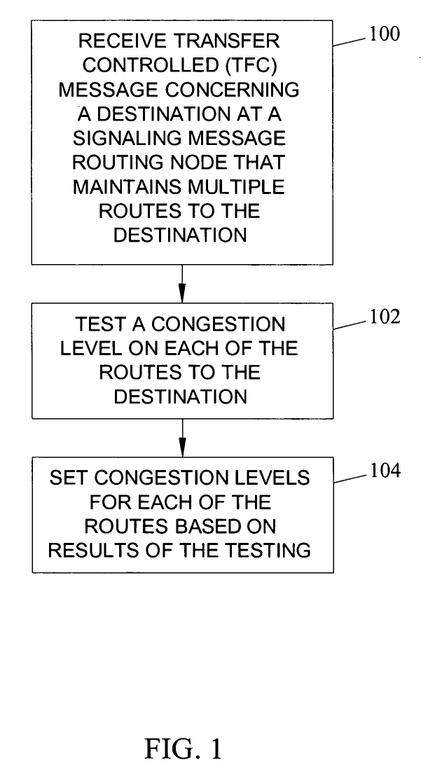

According to one aspect, the subject matter described herein includes a method for setting congestion levels for a plurality of routes to a common destination. For example, the signaling message routing node may maintain a primary route corresponding to the point code of a destination and one or more exception routes corresponding to the point code and one or more additional signaling message parameters. As described above, the additional signaling message parameters can include the SLS, the CIC, or the linkset on which a message was received. FIG. 1 is a flow chart illustrating exemplary overall steps for setting congestion levels for a plurality of routes to a common destination according to an embodiment of the subject matter described herein. Referring to FIG. 1, in step 100, a transfer controlled (TFC) message concerning a destination is received at a signaling message routing node that maintains a plurality of routes to a common destination. In step 102, a congestion level is tested on each of the routes to the destination. This can be contrasted with conventional TFC procedures where only a single route is tested. In step 104, the congestion levels are set for each of the routes based on results of the testing.

Testing the congestion level on each of the routes may be performed in any number of ways, depending on the goals of the system. In one method, referred to herein as the broadcast method, route set congestion test (RCT) messages may be broadcast on linksets corresponding to each route to a destination, and the congestion level for each of the routes may be set according to the level in a TFC message received over any of the linksets.

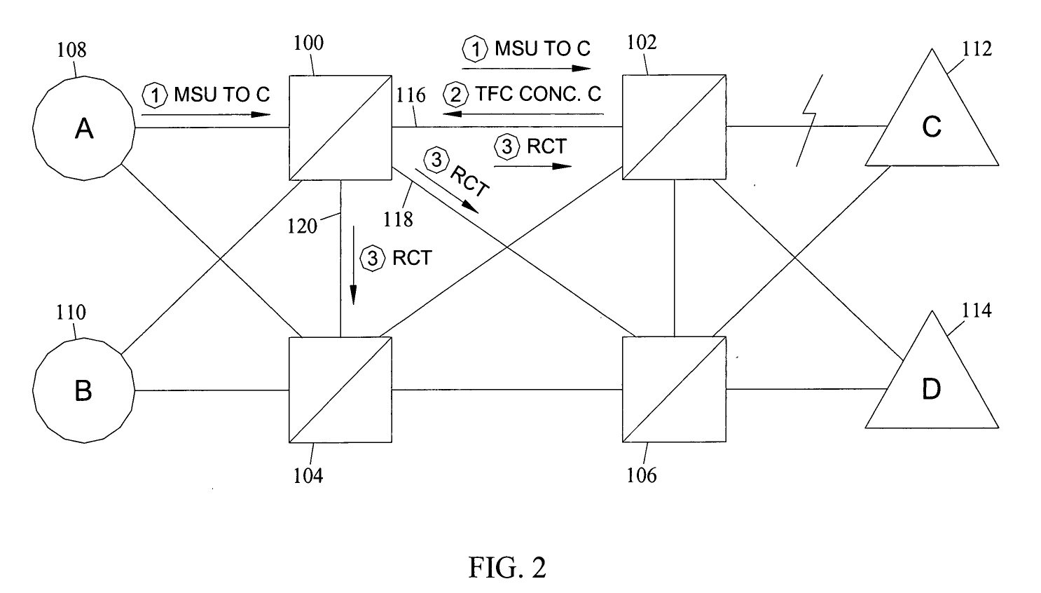

FIG. 2 is a network diagram illustrating exemplary messages exchanged between nodes and a broadcast congestion test method according to an embodiment of the subject matter described herein. Referring to FIG. 2, STPs 100, 102, 104, and 106 provide routing services between SSPs 108 and 110 and SCPs 112 and 114. In the illustrated example, it is assumed that a signaling link between STP 102 and SCP C 112 goes down and that STP 102 indicates that the destination SCP C 112 is congested. SSP A 108 sends an MSU to SCP C 112. STP 100 routes the MSU over an outbound linkset 116 to SCP C 112. STP 102 receives the MSU and detects that the priority level of the MSU is less than the current congestion level. Accordingly, STP 102 sends a TFC message concerning SCP C 112 to SSP A 108.

In this example, it is assumed that STP 100 maintains three different routes to SCP C 112. The first route corresponds to linkset 116 and is keyed by a destination point code parameter. The second route corresponds to linkset 118 and is keyed by a destination point code plus an originating linkset parameter. A third route corresponds to linkset 120 and is keyed by a destination point code plus a service indicator parameter. Using the nomenclature described above, the route corresponding to linkset 116 is the primary route and the routes corresponding to linksets 118 and 120 are exception routes.

Rather than sending the RCT solely on linkset 116, STP 100 may broadcast RCT messages on linksets 116, 118, and 120. As will be described in detail below, if a TFC message is received on any of the linksets, the STP sets the congestion level of all of the routes based on the congestion level in the TFC message. In addition, if a TFC message is not received on any of the linksets, the congestion level of all of the routes may be set to zero.

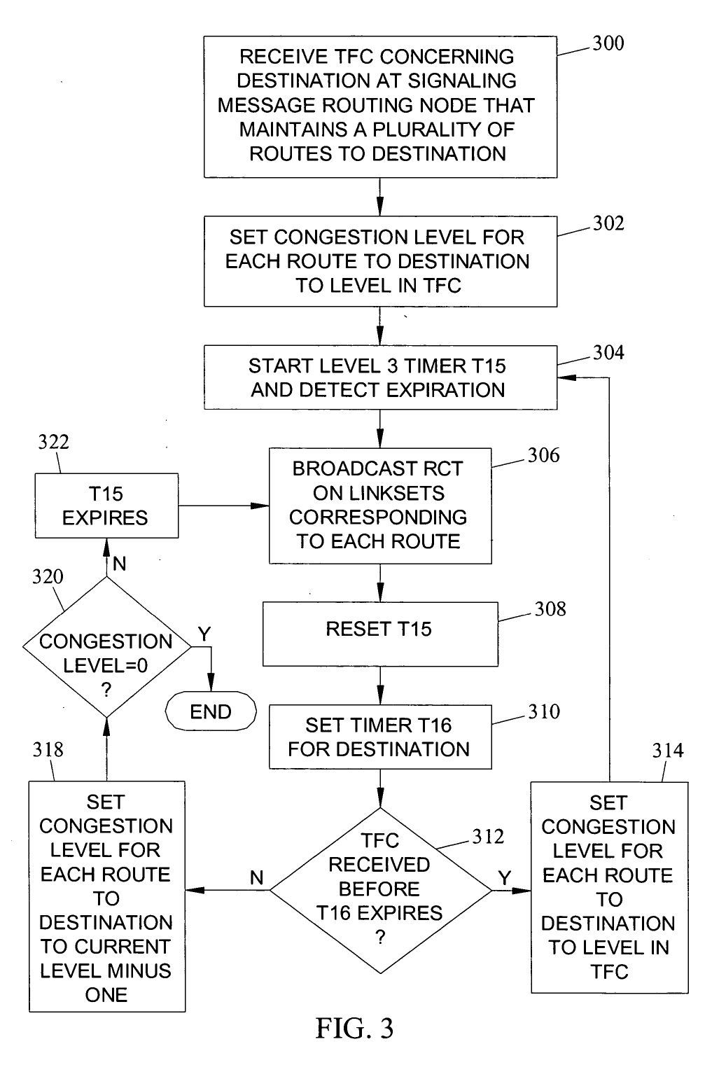

FIG. 3 is a flow chart illustrating exemplary detailed steps that may be performed by STP 100 in testing and setting congestion levels using the broadcast method illustrated in FIG. 2. Referring to FIG. 3, in step 300, a signaling message routing node, such as STP 100, receives a TFC concerning a destination. It is assumed that the signaling message routing node maintains a plurality of routes to the destination. In step 302, the signaling message routing node sets the congestion level for each route to the destination to the level in the TFC message. In step 304, the signaling message routing node starts a level 3 timer referred to as T15 and detects expiration of the timer T15. In step 306, the signaling message routing node broadcasts RCT messages on linksets corresponding to each route. In step 308, STP 100 resets the level 3 timer T15.

In step 310, the signaling message routing node sets another timer referred to as T16, for the destination. In step 312, the signaling message routing node determines whether a TFC has been received before the timer T16 expires. If a TFC is received before the timer T16 expires, control proceeds to step 314 where the signaling message routing node sets the congestion level for each route to the destination to the congestion level in the TFC. If the level in the TFC is the same as the current congestion level, no change is made. If multiple TFC messages are received with different congestion levels, the congestion level for the route may be set to the highest received level.

If a TFC is received, the route is still congested and additional testing is required. Accordingly, control proceeds 304 where T15 is restarted and its expiration is detected. Control then proceeds to step 306 where the RCT message is rebroadcast. The congestion level in the RCT message is set to one less than the current congestion level.

Returning to step 312, if a TFC message is not received before the timer T16 expires, control proceeds to step 318 where the congestion level for each of the routes is set to the current congestion level minus one. Control then proceeds to step 320 where the signaling message routing node determines whether the congestion level is zero. If the congestion level is zero, congestion testing procedures end. If the congestion level is not zero, control proceeds to step 322 where the timer T15 expires and then returns to step 306 where the RCT message is again broadcast on the linksets corresponding to each route. The priority level in the RCT message is set to one less than the current congestion level. Steps 306-320 are repeated until the congestion level is zero. The result of the left-hand loop (steps 306, 308, 310, 312,318, 320, and 322) in FIG. 3 is that the RCT message is rebroadcast every T15 seconds if no TFC is received until the congestion level is determined to be zero.

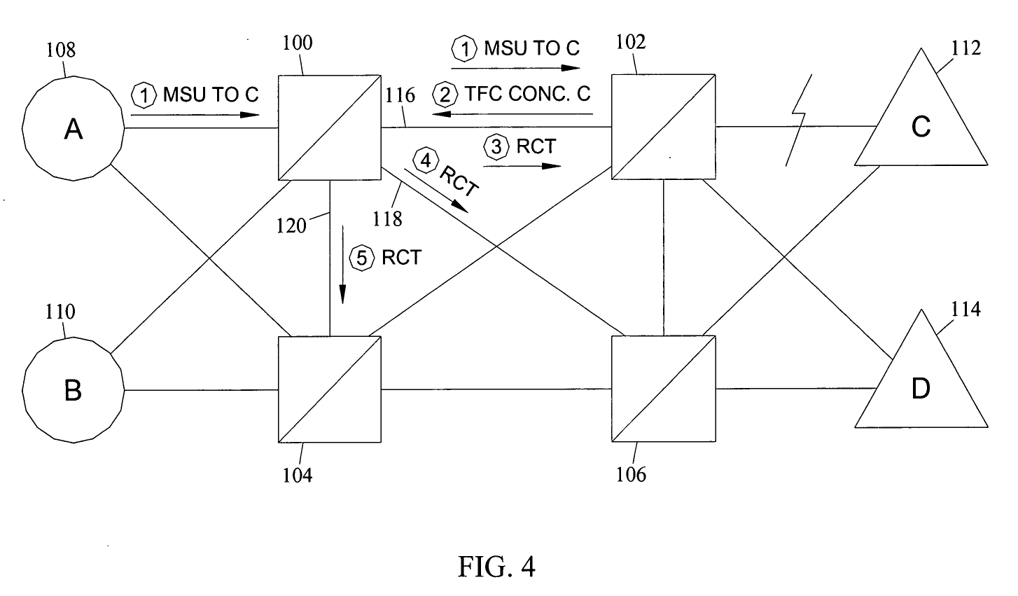

Using the steps illustrated in FIGS. 2 and 3, the congestion level for all of the routes to a congested destination, including the primary route and the exception routes, is set to the same level based on congestion on any of the routes. One advantage of this method is that it prevents oscillation between congested and non-congested states. One disadvantage of this method is that congestion on an exception route can unnecessarily mark a primary route as congested. In an alternate implementation, each route may be individually tested starting with the primary route and then congestion level on each route may be set based on the testing of that route. FIG. 4 is a network diagram illustrating this method, which will be referred to herein as the individual search method. Referring to FIG. 4, it is assumed that the linkset between STP 102 and SCP 112 goes down and that STP 102 detects congestion on the route corresponding to the linkset. SSP A 108 sends an MSU to SCP C 112. STP 100 routes the MSU over linkset 116 to STP 102. Because the route corresponding to the SCP C 112 is congested, STP 102 sends a TFC message concerning the point code of SPC C 112 to SSP A 108.

STP 100 receives the TFC concerning the point code of SCP C 112 and individually tests each route that includes the DPC of SCP C 112. In the illustrated example, STP 100 begins by sending an RCT message on linkset 116. STP 100 may test linkset 116 until congestion on the primary route abates to zero. STP 100 may repeat this procedure on linksets 118 and 120 until the congestion levels on each of these routes abates to zero.

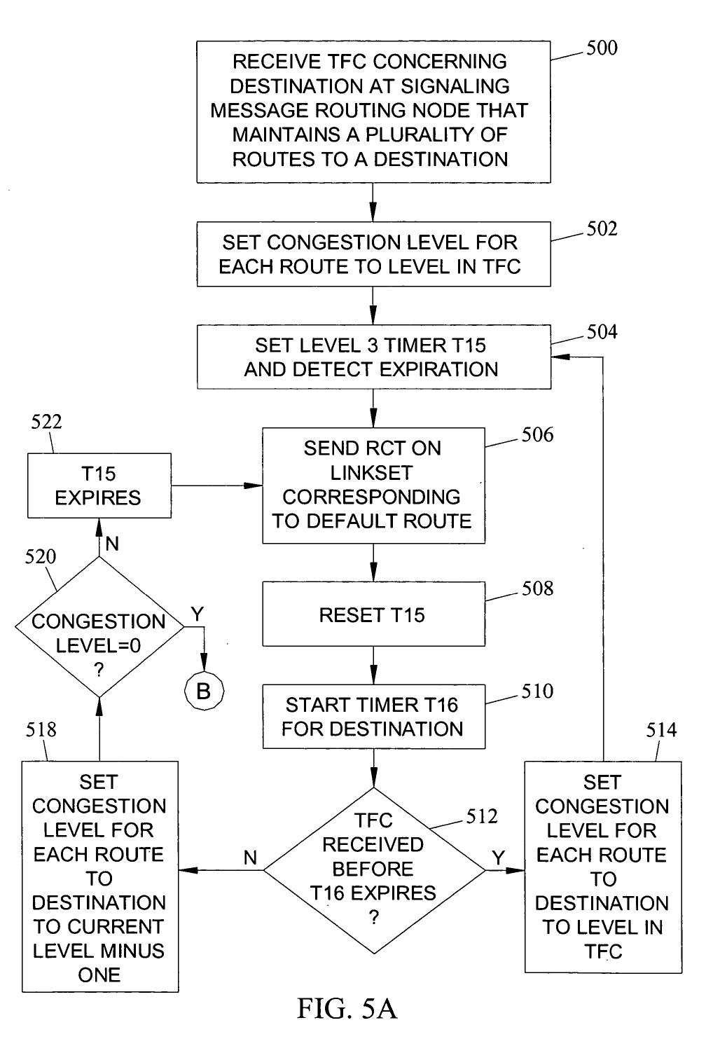

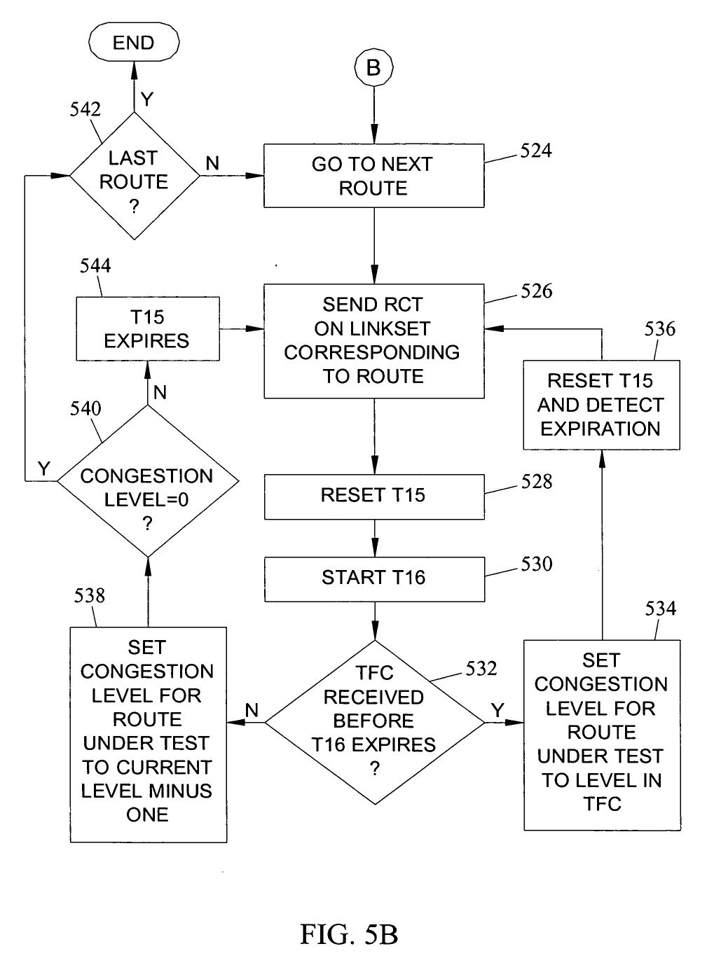

FIGS. 5A and 5B are a flow chart illustrating exemplary detailed steps corresponding to the individual search method illustrated in FIG. 4. Referring to FIG. 5A, in step 500, a signaling message routing node, such as STP 100, receives a TFC message concerning a destination. The signaling message routing node is assumed to maintain a plurality of routes to the destination. In step 502, the signaling message routing node sets a congestion level for each route to the congestion level in the TFC. In step 504, the signaling message routing node sets a level 3 timer T15 and detects an expiration of the timer.

In step 506, the signaling message routing node sends an RCT message on a linkset corresponding to the default route. As stated above, the default route may be the route that is keyed by the DPC only. In step 508, the signaling message routing node resets the timer T15. In step 510, the signaling message routing node starts a timer T16 for the destination. In step 512, the signaling message routing node determines whether a TFC has been received before T16 expires. If a TFC has been received, control proceeds to step 514 where the congestion level for each route is set corresponding to the level in the TFC. Control then returns to step 504 where T15 is restarted and its expiration is detected. Once T15 expires, control proceeds to step 506 where a new RCT message is sent over the congested route. The priority level in the RCT message is set to one less than the current congestion level.

Returning to step 512, if a TFC is not received before the timer T16 expires, control proceeds to step 518 where the congestion level for each route is set to the current congestion level minus one. In step 520, the signaling message routing node determines whether the congestion level is zero. If the congestion level for the default route is not zero, control proceeds to step 522 where the timer T15 expires, and control returns to steps 506 where a new RCT message is sent. The priority level of the new RCT message is set to the current congestion level minus one. The result of the left-hand loop in FIG. 5A is that an RCT message is sent over the default route every T15 seconds if no TFC is received until the congestion level is determined to be zero.

In step 520, if the congestion level for the default route is zero, control proceeds to step 524 in FIG. 5B where the first exception route is tested. Referring to FIG. 5B, in step 524, testing of the next route begins. In step 526, an RCT message is sent on the linkset corresponding to the next route. The next route may be one of the exception routes that is keyed by the DPC and one or parameters in addition to the DPC. The priority level of the RCT message is set to one less than the current congestion level. In step 528, the timer T15 is reset. In step 530, the timer T16 is started.

In step 532, the signaling message routing node determines whether a TFC is received before the timer T16 expires. If a TFC is received, control proceeds to step 534 where the congestion level for the route under test is set to the level in the TFC. In step 536, the timer T15 is reset, its expiration is detected, and control returns to step 526 where a new RCT message is sent on the linkset. The priority level in the RCT message is set to one less than the current congestion level.

Returning to step 532, if the TFC message is not received before the timer T16 expires, control proceeds to step 538 where the signaling message routing node sets the congestion level for the route under test to the current level minus one. Control then proceeds to step 540 where it is determined whether the congestion level is zero. If the congestion level is zero, control proceeds to step 542 where the signaling message routing node determines whether this is the last route being tested. If this is the last route being tested, the congestion testing ends. If this is not the last route being tested, control returns to step 524 where testing of the next route begins and to step 526 where an RCT is sent on the linkset corresponding to the next route.

Returning to step 540, if the congestion level for the route currently being tested is not zero, control proceeds to step 544 where the timer T15 expires. Control then returns to step 526 where an RCT message is sent on the current linkset. The priority level in the RCT message is set to one less than the current congestion level. The result of the left-hand loop in FIG. 5B (steps 526, 528, 530, 532, 538, 540, and 544) is that a new RCT message is sent on the route being tested every T15 seconds if no TFC is received until the congestion level is determined to be zero. Thus, using the steps illustrated in FIGS. 4, 5A, and 5B, routes are individually tested and the congestion level for each route is set based on the testing of each individual route.

Although in the example illustrated in FIGS. 4, 5A, and 5B, the routes are tested sequentially from the default route to the exception routes, the subject matter described herein is not limited to such an example. In an alternate example, the steps illustrated in FIGS. 5A for testing the default route may be performed simultaneously with the steps illustrated in FIG. 5B for testing the exception routes. Testing the default route and the exception route simultaneously will speed up the time for setting the appropriate congestion levels for each route. However, such testing requires greater processing power and more complex state machines at the signaling message routing node.

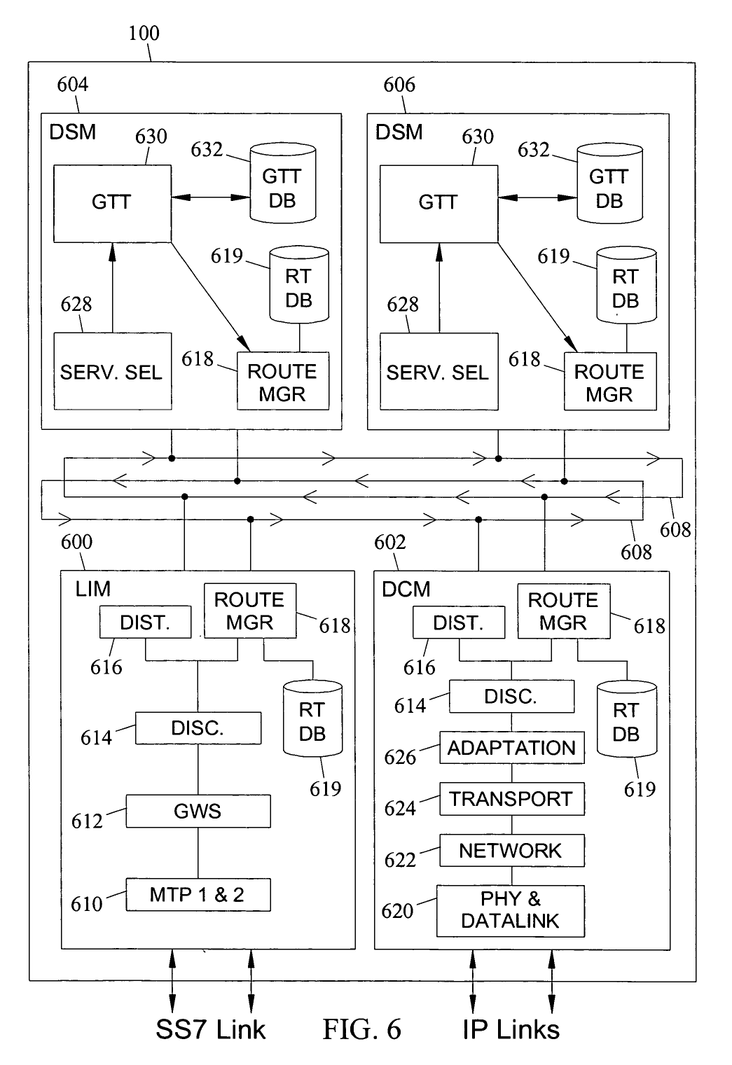

FIG. 6 is a block diagram illustrating an exemplary internal architecture for a signaling message routing node, such as STP 100, that maintains a plurality of routes to a destination and that tests and individually sets the congestion level on each route according to an embodiment of the subject matter described herein. Referring to FIG. 6, STP 100 includes a plurality of processing modules 600, 602, 604, and 606 connected via a counter-rotating, dual-ring bus 608. In the illustrated examples, processing module 600 comprises a link interface module. Link interface module 600 interfaces with SS7 signaling links. As such, link interface module 600 includes a message transfer part level 1 and 2 function 610, a gateway screening function 612, a discrimination function 614, a distribution function 616, a route manager 618, and a route database 619.

MTP level 1 and 2 function 610 performs MTP level 1 and 2 functions, such as sequencing, error detection, and error correction for SS7 signaling messages. Gateway screening function 612 performs gateway screening operations, such as screening messages based on destination point code or additional parameters in the messages. Discrimination function 614 examines the destination point code in received SS7 messages and determines whether to forward the message to an internal processing module in routing node 100 or to routing manager 618.

For messages that require internal processing, discrimination function 614 forwards these messages to distribution function 616. Distribution function 616 distributes these messages to the appropriate internal processing module within routing node 100. For messages that require routing, discrimination function 614 sends these messages to route manager 618. Route manager 618 examines the destination point code plus any additional parameters in the signaling message, performs a lookup in route database 619 using these parameters to identify an outbound signaling link, and routes the signaling messages to the interface module associated with the outbound signaling link. Route manager 618 may also implement the congestion management procedures described herein for testing and setting congestion levels for plural routes to a common destination.

Table 1 shown below illustrates exemplary parameters by which different routes to the same destination may be keyed in route database 619.

TABLE 1
Route Classes
Route Classes
DPC & OPC
DPC & Originating Linkset
DPC & CIC
DPC & SI
DPC

In Table 1, it is assumed that the route in the last row corresponds to the primary route. The remaining routes represent exception routes. As can be seen from the data in Table 1, the exception routes are keyed by the same DPC as the primary route plus additional parameters. The additional parameters include parameters such as the OPC, the originating linkset, the DPC, and the SI, which are associated with all SS7 signaling messages. Other parameters, such as the CIC parameter, are associated with ISUP messages. Accordingly, route classes illustrated in Table 1 may be used to route all types of SS7 signaling messages, including ISUP messages and SCCP messages, over one of a plurality of routes to a destination maintained by a signaling message routing node.

Module 602 comprises a data communications module for sending and receiving SS7 messages over IP signaling links. In the illustrated example, module 602 includes a physical and data link layer function 620, a network layer function 622, a transport layer function 624, an adaptation layer function 626, and function 614-618 described above with regard to module 600. Physical and data link layer function 620 may be implemented using any suitably physical and data link layer protocol, such as an Ethernet protocol. Network layer function 622 may implement any suitable network layer protocol, such as Internet protocol. Transport layer function 624 may implement any suitable transport layer protocol, such as UDP, TCP, or SCTP. Adaptation layer function 626 may implement any suitable SS7 adaptation layer protocol, such as M2PA, M3UA, SUA, or TALI, as described in the. corresponding Internet Engineering Task Force requests for comments. Functions 614-618 implement the corresponding operations described above with regard to LIM 600.

Modules 604 and 606 comprise database service modules for implementing database services for received messages. In the illustrated example, each of modules 604 and 606 includes a service selection function 628, a global title translation function 630, and a global title translation database 632. Service selection function 628 receives messages from other modules over bus 608 and determines the appropriate service to be applied to the messages. In the illustrated example, the service to be applied is global title translation. Other services, such as number portability translation, application layer screening, or other database services, may be applied without departing from the scope of the subject matter described herein. Global title translation function 630 performs a lookup in global title translation database 632 to determine a destination point code to be inserted in a message based on results of the global title translation. After the appropriate destination point code is inserted in the message, global title translation function 630 forwards the message to route manager 618, which routes the message to the interface module associated with the outbound signaling link.

In the examples described above, the signaling message routing node tests for congestion on a primary route and one or more exception routes to a destination maintained by the signaling message routing node. However, the subject matter described herein is not limited to testing for congestion on primary routes and exception routes. The subject matter described herein can be used to test and set the congestion levels on any set of a plurality of routes to a common destination maintained by a signaling message routing node.

It will be understood that various details of the present subject matter may be changed without departing from the scope of the present subject matter. Furthermore, the foregoing description is for the purpose of illustration only, and not for the purpose of limitation.

What is claimed is:

1. A method for setting congestion levels for a plurality of routes to a common destination, the method comprising:
(a) receiving a transfer controlled (TFC) message concerning a destination at a signaling message routing node that maintains a plurality of routes to the destination;
(b) testing a congestion level of each of the routes to the destination; and
(c) setting congestion levels for the routes based on results of the testing.

2. The method of claim 1 wherein receiving a TFC message at a signaling message routing node that maintains a plurality of routes to a destination includes receiving the TFC at a signaling message routing node that maintains a primary route keyed by a destination point code and at least one exception route keyed by the destination point code and at least one parameter in addition to the destination point code.

3. The method of claim 2 wherein the at least one exception route includes at a route keyed by an originating linkset and the destination point code.

4. The method of claim 2 wherein the at least one exception route includes a route keyed by a circuit identification code (CIC) parameter and the destination point code.

5. The method of claim 2 wherein the at least one exception route includes a route keyed by a service indicator (SI) parameter and the destination point code.

6. The method of claim 1 wherein testing a congestion level of each of the routes includes broadcasting route set congestion test (RCT) messages on linksets corresponding to each of the routes and setting a timer for the destination and wherein setting the congestion level for each of the routes includes setting the congestion level for all of the routes based on a congestion level associated with a response received for any of the routes.

7. The method of claim 1 wherein testing a congestion level of each of the routes includes sending a route set congestion test (RCT) message on a linkset corresponding to a primary route of the plurality of routes and setting congestion levels for the primary route and a remainder of the routes based on a response to the RCT message.

8. The method of claim 7 wherein testing a congestion level of each of the routes comprises, in response to determining that the primary route is not congested, individually sending RCT messages on linksets corresponding to each of a plurality of exception routes to the destination.

9. The method of claim 8 wherein setting congestion levels for the routes based on results of the testing includes setting congestion levels for the exception routes based on responses to the RCT messages sent on the linksets corresponding to the exception routes.

10. The method of claim 1 wherein testing a congestion level of each of the routes includes simultaneously testing each of the routes by sending RCT messages on linksets corresponding to each of the routes and individually setting congestion levels based on test results for each route.

11. A signaling message routing node for maintaining a plurality of routes to a common destination and for setting congestion levels for each of the routes, the signaling message routing node comprising:
(a) a route table for maintaining a plurality of routes to a common destination; and
(b) a route manager for receiving a transfer controlled (TFC) message concerning the destination, for testing a congestion level of each of the routes to the destination, and for setting congestion levels for the routes based on results of the testing.

12. The signaling message routing node for claim 11 wherein the route database includes at least one primary route keyed by a destination point code and at least one exception route keyed by the destination point code and at least one parameter in addition to the destination point code.

13. The signaling message routing node of claim 12 wherein the at least one exception route includes a route keyed by an originating linkset and the destination point code.

14. The signaling message routing node of claim 12 wherein the at least one exception route includes a route keyed by a circuit identification code (CIC) parameter and the destination point code.

15. The signaling message routing node of claim 12 wherein the at least one exception route includes a route keyed by a service indicator (SI) parameter and the destination point code.

16. The system of claim 11 wherein the route manager is adapted to test a congestion level of each of the routes by broadcasting route set congestion tests (RCT) messages on linksets corresponding to each of the routes and setting a timer for the destination and wherein, in setting the congestion level for each of the routes, the route manager is adapted to set the congestion level for all of the routes based on a congestion level associated with a response received for any of the routes.

17. The signaling message routing node of claim 11 wherein the route manager is adapted to send a route set congestion test (RCT) message on a linkset corresponding to a primary route of the plurality of routes and to set congestion levels on the primary route and on a remainder of the routes based on a response to RCT message.

18. The signaling message routing node of claim 17 wherein the route manager is adapted to, in response to determining that the primary route is not congested, individually send RCT messages on linksets corresponding to each of a plurality of exception routes to the destination.

19. The signaling message routing node of claim 18 wherein the route manager is adapted to set congestion levels for the exception routes based on responses to the RCT messages sent on the linksets corresponding to the exception routes.

20. The signaling message routing node of claim 11 wherein the route manager is adapted to simultaneously test congestion of each of the routes by sending RCT messages over linksets corresponding to each of the routes and set congestion levels based on test results for each route.

21. A computer program product comprising computer executable instructions embodied in a computer readable medium for performing steps comprising:
(a) receiving a transfer controlled (TFC) message concerning a destination at a signaling message routing node that maintains a plurality of routes to the destination;
(b) testing each of the routes to the destination; and
(c) setting congestion levels for the routes based on results of the testing.

22. The computer program product of claim 21 wherein receiving a TFC at a signaling message routing node that maintains a plurality of routes to a destination includes receiving a TFC at a signaling message routing node that maintains a primary route key by a destination point code and at least one exception route keyed by the destination point code in one parameter in addition to the destination point code.

23. The computer program product of claim 22 wherein the exception routes include at least one route key by a destination point code and an originating linkset.

24. The method of claim 22 wherein the exception routes include at least one route key by a CIC parameter in the destination point code.

25. The computer program product of claim 22 wherein the exception routes include a route key by a service indicator parameter and the destination point code.

26. The computer program product of claim 21 wherein testing each of the routes includes broadcasting route set congestion test (RCT) on linksets corresponding to each of the routes and setting a timer for the destination and wherein setting the congestion level for each of the routes includes setting the congestion level for all of the routes based on a response received from any of the routes.

27. The computer program product of claim 21 wherein testing each of the routes includes testing a primary route of the plurality of routes and setting congestion levels for each of the routes based on congestion status of the primary route.

28. The computer program product of claim 27 comprising, after testing the primary route, in response to determining that the primary route is not congested, individually testing each of the secondary routes to the destination.

29. The computer program product of claim 28 wherein setting congestion levels for the routes based on results of the testing includes setting congestion levels for the exception routes based on responses to the RCT messages sent on the linksets corresponding to the exception routes.

30. The computer program product of claim 21 wherein testing each of the routes includes simultaneously testing each of the routes by sending RCT messages to each of the routes and individually setting congestion levels based on test results for each route.
